(19) United States
(12) Patent Application Publication
(10) Pub. No.: US 2022/0363076 A1
(43) Pub. Date: Nov. 17, 2022

(54) PROVIDING A STATUS OF A RADIATION EMITTER

(71) Applicant: Hewlett-Packard Development Company, L.P., Spring, TX (US)

(72) Inventors: Raimon CASTELLS DE MONET, Sant Cugat del Valles (ES); Josep TARRADAS I JUAN, Sant Cugat del Valles (ES); Jordi BLANCH COSTA, Sant Cugat del Valles (ES)

(73) Assignee: Hewlett-Packard Development Company, L.P., Spring, TX (US)

(21) Appl. No.: 17/767,023

(22) PCT Filed: Nov. 11, 2019
(86) PCT No.: PCT/US2019/060752

§ 371 Date: Apr. 6, 2022

(51) Int. Cl. B41J 11/00; G01J 3/50; G01J 3/52

(52) U.S. Cl. CPC B41J 11/00214; B41J 11/00216; G01J 3/50; G01J 3/524

(57) ABSTRACT

Examples of the present disclosure relate to a method for providing a status of a radiation emitter of a printing device, the method comprising image sensing at least part of a print agent after deposition onto a print substrate and after heating by the radiation emitter: obtaining, based on the image sensing, an irradiance applied on the heated print agent and providing a status of the radiation emitter in response to determining a deviation of the irradiance with respect to an expected irradiance.

### BACKGROUND

Sublimation printing processes may be used to print and fix images on a textile material, e.g. a garment fabric. A print agent may be applied to the textile material, sublimated and absorbed by fibers of the textile material to print and fix an image on the textile material, also known as substrate. Dye sublimation may be a method to print on polyester based substrates. In dye sublimation, colors after printing may appear lighter than expected and they may become more intense after being heated. When a heating process or an activation of a chemical reaction is required in printing systems, a radiation emitter may be used.

A uniformity of the radiation received by a target substrate may be considered to provide printer performance parameters such as good image quality, like banding or color consistency, and durability.

### BRIEF DESCRIPTION OF THE DRAWINGS

FIG. 1 is a representation of an example of a method according to the present disclosure.

FIG. 2 is a representation of an example result of a method according to the present disclosure.

FIG. 3 is a representation of an example of a method according to the present disclosure.

FIG. 4 is a representation of an example of a method according to the present disclosure.

FIG. 5 is a representation of an example of a system according to the present disclosure.

FIG. 6 is a representation of an example of a system according to the present disclosure.

FIG. 7 is a representation of an example of a system according to the present disclosure.

### DETAILED DESCRIPTION

Printing an image on a print substrate may involve delivering a print agent on a print substrate with a print head of a printing system.

A print substrate is a material capable of receiving a print agent. In some examples, a print substrate may be a textile material. Textile materials may comprise cotton or polymers, e.g. polyester. In some examples, the print substrate may be a sheet of paper or cardboard or a plastic material. hi the textile sector, an image may be directly or indirectly printed on a textile material by using a dye sublimation printing process. Dye sublimation printing, also known in the art as “dye-sub”, is a process to print on textile substrates, e.g. garment fabrics. In an example, an image may be printed onto a textile substrate provided in a roll or sheet format whereas in further examples, the image may be printed directly onto a garment e.g. to a polyester fabric or to a polymer-coated substrate fabric. Some dye-sub methods may involve printing an image onto a sublimation transfer printable media or substrate, e.g. paper, with a printing system and transferring this image to a final substrate.

Printing processes may comprise heating. Heat may be applied to this delivered or deposited print agent in some printing processes. The print agent on the print substrate may be heated by conduction, convection or radiation or a mixed of any of them. For example, a heating system having a radiation emitter may heat or radiate a print agent on the print substrate and a print agent on a print substrate may therefore be irradiated by a heating system. Examples of heating in printing process may be drying, curing, sublimating or fixing. Such heating processes may involve warming up the radiation emitter to a predetermined temperature before irradiating the print agent. Other heating systems such as solid-state emitters, for example LED, or VCSEL may not be previously warmed up.

Some printing processes may include a drying process in which a print agent, e.g. ink, is heated to a temperature higher than a drying temperature to accelerate the evaporation of solvent fluids and leave the pigments on the print substrate. The drying temperature may depend on the type of print agent. In some examples, a drying temperature for a given print agent, e.g. ink, may be between 50° C. and 100° C. In some examples, a drying temperature may be between 50° C. and 80° C. Heating the print agent to a temperature higher than a drying temperature may involve a radiation emitter at a temperature higher than a predetermined temperature. In some examples, this predetermined temperature of the radiation emitter may be similar or higher than the drying temperature of the print agent.

Some printing processes may comprise curing a print agent deposited or ejected onto the print substrate. Some print agents may comprise a solvent liquid, a pigment and latex particles. The solvent liquid, e.g. water-based solvent, may be evaporated in a drying process. Then, in a curing process, the print agent may be irradiated, and the latex particles may be melted to form a film that encapsulates the pigment. A radiant emitter may provide energy for curing the print agent after the radiant emitter reaches a predetermined temperature. In some examples, curing a print agent may involve heating the radiant emitter to a temperature between 90° C. and 150° C.

Some printing processes may comprise sublimation. In a sublimation printing process, a print agent, e.g. ink, is converted from a solid to a gaseous state to penetrate into a textile substrate to form an image. At a predetermined temperature, i.e. at or above a sublimation temperature, a print agent is converted to gas which permeates the fibers of the fabric. The gas is again converted to a solid state when the temperature drops, and the print agent is thus absorbed and integrated into the fibers. An image is thus printed on a fabric, e.g, a polyester garment fabric or to a polymer-coated substrate garment fabric. A sublimation temperature of the print agent may be between 110° C. and 220° C. In some examples, the print agent may be heated to a temperature at or above the sublimation temperature of the print agent. For example, ink may be heated to a temperature between 195° C. and 260° C. Ink may be sublimated in 0.1 to 10 seconds, e.g. between 3 to 5 seconds.

In order to reach the predetermined temperature, or a temperature above a sublimation temperature, a radiation emitter may be used. During sublimation, an energy is applied on a substrate which comprises applying a power density on a substrate during a specific period of time. Irradiating comprises applying a radiation power per surface unit. Examples of the methods and systems disclosed herein may be used to provide a status of a radiation emitter. Examples of the methods and systems disclosed herein may further calibrate such radiation emitter when a deviation status is determined or provided.

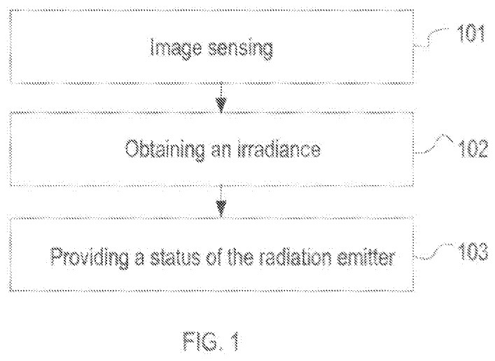

This disclosure relates to a method for providing a status of a radiation emitter of a printing device, as exemplified in FIG. 1. FIG. 1 represents an example method comprising: image sensing (101) at least part of a print agent after deposition onto a print substrate and after heating by the radiation emitter, obtaining (102), based on the image sensing, an irradiance applied on the heated print agent and providing (103) a status of the radiation emitter in response to determining a deviation of the irradiance with respect to an expected irradiance.

A status may be related to a uniformity of the radiation received by a target substrate, which may be analyzed from printer performance parameters such as image quality, printing banding, color consistency. A status may be provided in a graphical format, for example on a map in which parts of the substrate may be signaled with information about color parameters per surface unit, image quality, printing banding values or color consistency. A status may be a deviation status, as it will be explained further below. A status may be a correct status, which may involve that no actions need to be further performed on the radiation emitter.

The method comprises image sensing at least part of a print agent after deposition onto a print substrate and after heating by the radiation emitter.

Image sensing (101) may be performed by any type of light sensor. In other words, image sensing may be performed by any device capable of providing information about a light, color, or about electromagnetic waves or about a light beam emanating from a surface. In the context of the present disclosure image sensing may be performed by a scanner, or by a camera or by a spectrophotometer. A spectrophotometer may provide a point to point measure of light values emanating from a substrate and may build a vector and or a matrix with such information. An imager or camera may comprise electronic means for processing an image and to convert such image into a digital image. In the context of the present disclosure, digital image and image may be indistinctly used. An image sensor or imager is a sensor which may detect and convey information used to elaborate an image. The detection and transmission may be made by converting light waves, as they pass through or reflect from objects for example a print substrate, into signals or small bursts of current that convey the information. The waves can be light or other electromagnetic radiation. Image sensors may be used in electronic imaging devices of both analog and digital types, which may include digital cameras, thermal cameras, camera modules, medical imaging equipment, night vision equipment, radar or sonar.

Deposition of a print agent onto at least a part of print substrate may comprise dropping or ejecting a predetermined quantity of a print agent, for example ink, onto a substrate or on a first print zone of a substrate. The substrate may be a polymer-coated substrate.

Heating by the radiation emitter may comprise radiating with the radiation emitter. In some examples, the radiation emitter may emit radiation in a relatively wide band, e.g. in at least part of the infrared spectrum. In some examples, the radiation emitter may emit infrared (IR) radiation. Infrared radiation may emit with a wavelength between 700 nm and 1 mm. In some examples, the radiation emitter may emit ultraviolet (UV) radiation. An infrared radiation emitter may emit a part of a radiation comprising a wavelength in the visible spectrum. Ultraviolet radiation has a wavelength between 10 nm to 400 nm. In some examples, the radiation emitter may emit radiation in a relatively narrow band. Light-emitting diodes (LED's) or laser diodes are examples of radiation emitters with a relatively narrow band. An emitter may comprise for example a UV-LED lamp or a laser emitter.

Image sensing at least a part of a print agent after deposition onto a print substrate and after heating by the radiation emitter may comprise image sensing a specific part of a printed and sublimated substrate or a complete area of a printed and sublimated substrate.

The method further comprises obtaining (102), based on the image sensing, an irradiance applied on the heated print agent.

An irradiance, or flux density of radiant energy, is the power incident on a unit area and may be expressed as W/m² (i.e. J/m²s). In particular, direct beam solar irradiance may be defined as the irradiance of a sun's direct beam measured on a plane perpendicular to the beam. A method according to the present disclosure allows obtaining the irradiance applied on the printed substrate based on the image sensing. Obtaining such irradiance may comprise transforming color values of the printed substrate which are imaged at the image sensing step into irradiance values applied on the substrate. For example, it may comprise translating one or more color values obtained at the image sensing step into an irradiated power per surface unit, e.g. per mm² or per cm² of the at least part of the print substrate. The color values may depend on the printed and sublimated substrate. Translating one or more color values may comprise translating one or more parameters of a color space, obtained at the image sensing step, into an irradiated power per centimeter squared, cm², of the at least part of the print substrate. A color space may be defined with 3 parameters, and the format may be for example, luminosity, L*, or luminosity, chroma and color tone, also known as L*ab, or for example the parameters of a color space XYZ, or RGB, or others. For example, a spectrophotometer may be used for image sensing, wherein the spectrophotometer may provide with parameters of a color space such as L*ab. The irradiance may be obtained by a known function “f”, wherein f may provide with an irradiance depending on color values or parameters of a color space. The function f may therefore be defined as f (color values), for example f(L*ab)=irradiance. As disclosed, the spectrophotometer may provide with color values, such as XYZ, and/or L*ab for a scanned or imaged area of a substrate, but internally, the spectrophotometer may process an irradiated power per wavelength within a range of wavelengths, for example in the visible spectrum, from 380 nm to 740 nm.

In some examples, a translation may be made by matching, in a look-up table, color values with irradiance power values in milliwatts per centimeter squared, for example, mW/cm². In some examples, a look-up table or a formula or function “f” may be bunt by measuring luminosity, L*, on a substrate or in a blue substrate wherein different radiances may be applied. A curve L*, describing luminosity, may be obtained per radiation applied, wherein each radiation corresponds to a point in the curve L*. Said curve may be used to complete a look-up table or to build a formula or function. In some examples, a look-up table may be built by testing a same image and applying different radiances on the image. In some examples, a look-up table may be built per substrate or type of substrate, for example, a table may be built per density of the substrate or per thickness or per pattern of the substrate. A curve L*ab may be obtained per radiance, describing luminosity, chrome and color tone, wherein each radiation applied may correspond to a point in the curve L*ab. Said curve may be used to complete a look-up table or to build a formula and may provide better precision than the curve measuring only luminosity, L*.

A translation may comprise providing irradiance values depending on one or more variables of a list comprising: a print substrate, a distance between the print substrate and the radiation emitter, an image sensor aperture, an image sensor illumination, a light source position with respect to the print substrate and a light incidence angle on the print substrate. For each variable, a look up table may be built. A function of irradiance=F(variables) may vary depending on all or some of the variables listed or may vary depending on other variables.

The method further comprises providing (103) a status of the radiation emitter in response to determining a deviation of the irradiance with respect to an expected irradiance.

Determining a deviation of the irradiance with respect to an expected irradiance may comprise subtracting one or more irradiance values applied on the print substrate from one or more expected irradiance values. For example, an expected value may be obtained by experimentally testing a lamp, for example a UV-LED, in a laboratory. An intensity may be increased for the lamp and an irradiance sensor, such as a radiometer, may be used to note the response of an irradiated substrate. The noted values may describe the expected irradiance values. If, for example, an expected irradiance response is 10 mW/cm² and an obtained value of 9 mW/cm² is obtained, then a deviation is determined. An expected value may be obtained per each set of variables: a print substrate, a distance between the print substrate and the radiation emitter, an image sensor aperture, an image sensor illumination, a light source position. A variation of any of the listed variables may modify the reference values.

Providing (103) a status of the radiation emitter may comprise providing a signal responsive to determining a deviation different from 0 from the expected irradiance. Providing (103) a status of the radiation emitter in response to determining a deviation of the irradiance with respect to an expected irradiance may comprise providing a first signal responsive to determining a deviation equal to 0 in the irradiance and/or providing a second signal if the deviation is different from 0. Providing a status may comprise providing a signal or a first signal or a second signal if more than a predetermined area, for example 5 cm², of the imaged substrate deviates from the expected irradiance in a threshold of surface units, for example if more than 5 cm² of the surface of the substrate deviate from their expected irradiances. The provided status may be provided by a graphical signal on a graphical user interface, or as a sound signal or sound alert, or as any other type of signal. A status may be a deviation status or a calibration status if, for example, the deviation is different from 0 or an absolute value of the deviation is different from 0. A status may be a correct status, which may involve that no actions need to be further performed on the radiation emitter, if the deviation is 0. If a provided status is a deviation status, the radiation emitter may need to be calibrated or reconfigured, or replaced, or adjusted.

The synergic effect of translating color values into irradiances in order to provide a status of a radiation emitter depending on a deviation of an irradiance may be that a radiation emitter may be efficiently tested. If a status is provided, and a deviation thereby detected, then a correct calibration may be performed on a radiation source such that a correct sublimation is achieved on a substrate by applying a dose of calibrated radiation which achieves an optimal sublimation in terms of quality. The method of the present disclosure allows therefore to identify an optimal radiation for a given substrate. Furthermore, the detection of failures in the radiation source is improved. For example, by providing a method according to the present disclosure, the tooling required to obtain an irradiance based on an image may be reduced with respect to other methods.

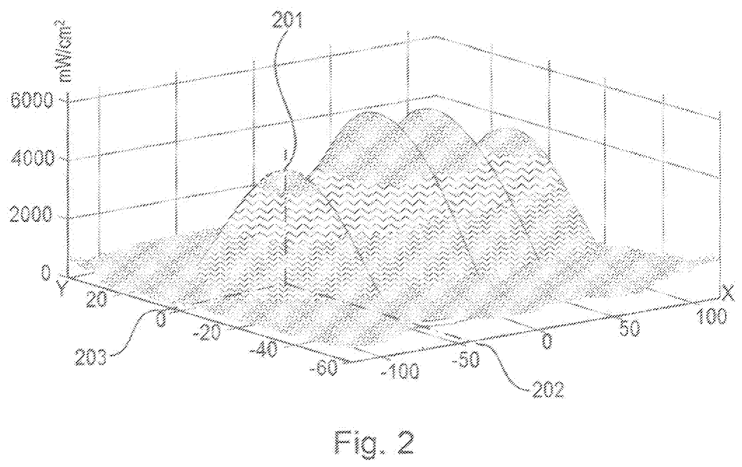

As seen in FIG. 2, a mapped irradiance may be provided by a method according to the disclosure, reducing the need of a dedicated apparatus, such as a radiometer, which may provide an irradiance measurement on a single point of a substrate and for a specific wavelength range. FIG. 2 represents an irradiance map on an area of a substrate, were the values of intensity of irradiance in mW/cm² have been obtained by a method according to the present disclosure. A status of the radiation emitter may be provided by graphically representing, in a different pattern, for example in dashed lines, the lobe (201) or lobes which may deviate from an expected irradiance. A user may directly verify that in the signaled lobe (201) of the area of the substrate, corresponding to a point or set of points represented in the FIG. 2 as (X, Y)=(202, 203) of the emitter, there is a zone of UV-LEDs which are not emitting properly and/or uniformly or with an emission which provides an accepted quality of a sublimated image. A graphic representation may also comprise the area of the substrate deviating from a reference, so that a specific lamp or set of UV-LEDs in the emitter may be easily identified for calibration, i.e.: for increasing or decreasing the irradiation power, or for replacement or for adjustment of temperature. UV-LED lamps may typically comprise sets or clusters of LEDs covering an area around 4 cm×6 cm. If one or more LEDs of a lamp are identified to be defective or to need calibration, i.e.: adjustment or replacement, then a whole cluster or more than one cluster may be calibrated or replaced.

By scanning several points under an emitter, a map of the emitter all along the emission area may be obtained. This process is typically done manually with a radiometer and may take significative time, for example more than 10 min. The process typically requires stopping a printing process, putting the radiometer in place and performing the measurement. In cases where there are multiple emitters of different wavelengths contributing to the final irradiance, it may be required to scan several times, using each time a different emitter according to the different wavelengths contributing to the final irradiance. A radiometer may require some specific knowledge to be managed. In contrast, a method according to the present disclosure does not require specific tooling.

The methods described herein allow avoiding the use of specific radiometers and dedicated tooling. The image sensors used to provide the image sensing may be already available in some printers, for example a spectrophotometer embedded in some printers. The process of obtaining an irradiance is simplified, since there is no need to use a radiometer under an emitter in different places and afterwards analyze the data. Such fact reduces the time to obtain the irradiance. There is not wavelength limitation in terms of the emitter radiation, since with the proposed method, it is possible to measure an emitter's radiation from ultraviolet to far infrared spectrum without changing any hardware or sensor implementing the described method.

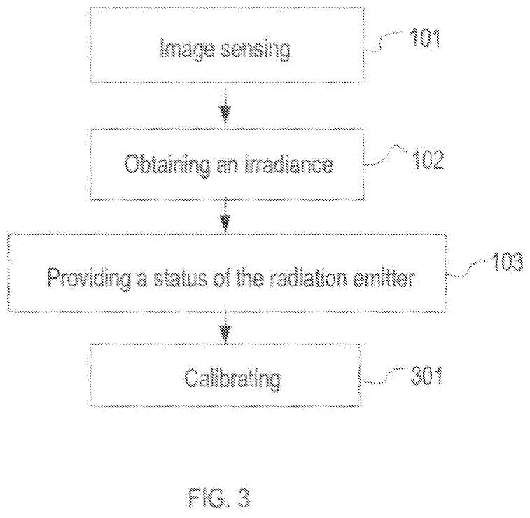

In some examples, a method according to the present disclosure may comprise, as seen in FIG. 3, calibrating (301) the radiation emitter when the status is a calibrating status.

Calibrating (301) the radiation emitter may comprise modifying a radiance power of the radiation emitter in response to determining a deviation of the irradiance with respect to an expected irradiance. Calibrating may comprise replacing or adjusting the radiation emitter. A calibrating status may be a deviation status and may comprise that the deviation determined in at least a threshold parameter of surface units of the printed substrate deviates from the expected irradiance. A calibrating status may comprise that the deviation determined in the printed substrate deviates from the expected irradiance more than, for example, 5%, or 7% or 10% of the expected irradiance. A calibrating status may comprise that the deviation determined in at least a threshold parameter of surface units of the printed substrate deviates more than 5%, or 7% or 10% of the expected irradiance. Calibrating (301) the radiation emitter may comprise modifying a radiance power of the radiation emitter in response to determining a deviation of the irradiance with respect to an expected irradiance. Modifying a radiance power may comprise increasing or decreasing the intensity of the radiation source, for example a lamp, or a UV-LED lamp. Calibrating (301) the radiation emitter may comprise replacing a lamp or a set of lamps conforming the emitter. The calibration may be made by sending control signals to the emitter, which control signals may be sent from a user interface, or from an algorithm running on a processor of an emitter or a processor of a printer. A system comprising dedicated tooling may receive instructions for replacing a radiation emitter, or a cluster or set of LED lamps of a UV-LED lamp emitter from a processor, after the processor implementing a method according to the present disclosure detects a calibrating status.

The detection and correction of failures in the radiation source may be improved with a method according to this example.

A method in accordance with the present disclosure may further comprise, before performing the image sensing; depositing a print agent onto a print substrate; and heating the print agent by the radiation emitter. A method according to this disclosure may comprise a dye-sublimation technique on a substrate before image sensing the substrate. This example method consists in measuring with a sensor, for example a sensor comprised in an embedded spectrophotometer of a printer, also known as SOL, a pre-printed image after being sublimated using a radiation device to characterize the irradiance response of the substrate. The pre-printed image may have one or multiple areas filled with pre-selected colors to provide a best noise to signal ratio. In an example, the method may be tested using a blue pre-colored substrate to assess feasibility of the method in the worst-case conditions, since a blue substrate is the most sensitive colored substrate to radiation. The result is an irradiance map for the exposed area.

A method according to the present disclosure may comprise calibrating printing parameters in response to determining a deviation of the irradiance with respect to an expected irradiance.

The method may also be used to adjust printer parameter settings with a customer target metric, since the final data obtained is image quality or color metrics. If for example a deviation is determined which may require increasing the irradiation power of the emitter in an amount which may deteriorate the substrate, for example, which may burn a part of the substrate, a processing algorithm may evaluate that it may be technically more efficient and safe to vary both a first part of the amount of the radiance power of the emitter and the printing parameters.

Varying the printing parameters, e.g. colors, would compensate for a second part of the amount of the radiance power which is avoided for not burning the substrate. The method may be implemented at customer site at a predetermined periodicity to ensure the best performance all along the printer life and/or the emitter life.

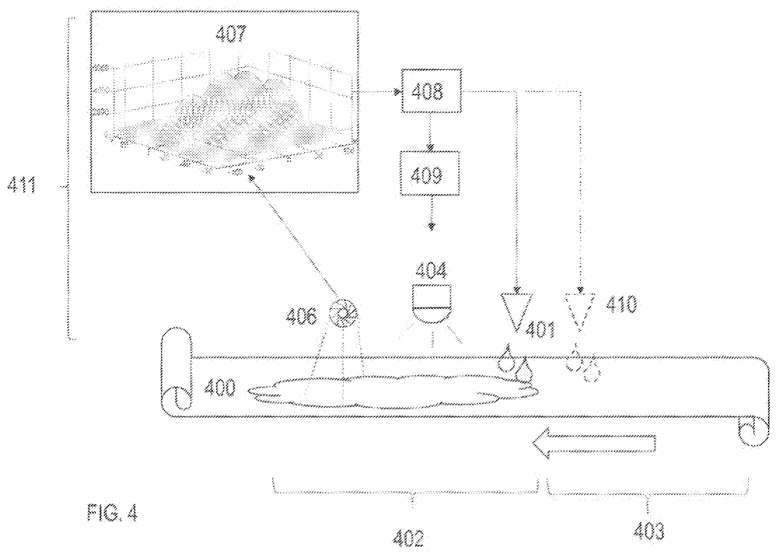

As shown in FIG. 4, the method may comprise in some examples:
depositing (401) a print agent onto the print substrate (400) comprises depositing print agent to print a first part (402), out from a first (402) and a second part (403), of a print job;
heating comprises heating (404) at least part of the deposited print agent by the radiation emitter (405);
image sensing comprises image sensing (406) at least part of the heated print agent;
obtaining an irradiance comprises obtaining (407) an irradiance applied on the at least part of the heated print agent based on the image sensing;
   and wherein the method further comprises
calibrating (409) the radiation when the status is a calibrating status, which may comprise determining a deviation (408) of the irradiance with respect to an expected irradiance;
depositing (410) further print agent onto the print substrate to print the second part (403) of the print job.

Depositing (410) a further print agent onto the print substrate to print the second part of the print job may comprise printing with the same printing parameters as in the first printing or printing with calibrated printing parameters.

After depositing (410) further print agent onto the print substrate to print the second part of the print job, the further print agent is sublimated by the calibrated or not calibrated radiation emitter. The radiation emitter, as previously said, is calibrated after determining that there exists a deviation of the irradiance with respect to an expected irradiance. In the case where the deviation is 0 or it is considered that there does not exist a deviation, the calibration may not be performed, and neither the radiation emitter nor the printing parameters are modified or calibrated for printing and sublimating the further printing agent deposited for printing the second part (403) of the print job.

In FIG. 4 the arrow may represent a movement direction or an advancing direction of the substrate with respect to the system (411) composed of the injector, the emitter, the image sensor and the processing means for obtaining (407) an irradiance, for obtaining (408) a deviation and for calibrating (409) the radiation source. As it may be understood, the system (410) may move with respect to the substrate and the substrate may remain static.

The method may comprise in some examples:
depositing a print agent onto the print substrate comprises depositing print agent to print a first part, out from a first and a second part, of a print job;
heating comprises heating at least part of the deposited print agent by the radiation emitter; image sensing comprises image sensing at least part of the heated print agent;
obtaining an irradiance comprises obtaining an irradiance applied on the at least part of the heated print agent based on the image sensing; and wherein the method further comprises
calibrating the radiation when the status is a calibrating status, which may comprise determining a deviation of the irradiance with respect to an expected irradiance;
depositing further print agent onto the print substrate to print the second part of the print job;
and wherein a first part and a second part of the print job cover areas of variable surface of the print job based on properties of the print job.

In this example method, a first part and a second part of the print job cover areas of variable surface of the print job based on properties of the print job. The variable areas of the print job may be varied depending on the color parameters of each part or depending on pre-established dimensions, for example, every 5 cm of a dimension run in the advancing direction, the radiation emitter may be evaluated, an irradiance value of the substrate may be obtained and a status and possible calibration may be performed. The method may be iteratively repeated until a complete print job is finished. For example, a first part may cover 5 or 7 cm or any other size of a dimension of the print job, for example in the advancing direction, since such first part may be used as a pre-calibration part for printing the print job. After a first pre-calibration, the print job may continue to be printed with calibrated parameters, or may continue to be printed by parts, for example, each time that a considerable change of color in the print job arrives, the calibrating steps may be iterated; this is, obtaining an irradiance of a part of the substrate, determining a deviation and calibrating the emitter or the emitter and printing parameters in the case where a deviation is different from 0.

In some example methods, providing a status of a radiation emitter may be performed iteratively, whereby iterations may be performed using machine learning methods. In an example, a machine learning method includes a classification method. In an example, the classification method corresponds to one or more of support vector machines (SVM), random forest (RF) and artificial neural networks (ANN). The machine learning methods may determine which latency is optimal for a given substrate or for given properties of a print job, so that the iterations are performed with a periodicity or latency given be the machine learning algorithms.

The example shown in FIG. 4 represents a non-limitative example. In some examples, a heating or radiation emitter may be independent from a printing system. For example, the radiation emitter may be adjacent to the printing system.

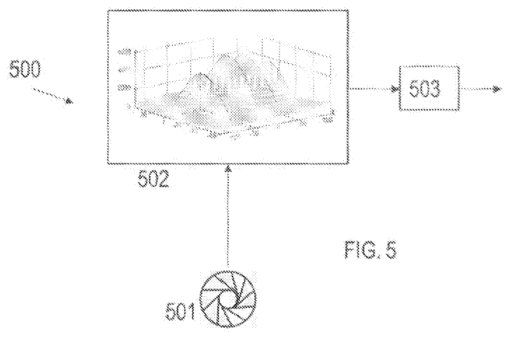

As represented in FIG. 5, a system (500) for regulating a radiation source may comprise:
a light sensor (501) to provide a scan of at least part of a sublimated print agent, the print agent deposited on a substrate and sublimated by the radiation source;
an irradiance correlator (502) to correlate the scan to an irradiance value;
a control unit (503) in communication with the radiation source to regulate the radiation source in response to a deviation of the irradiance value with respect to an expected value or range of values.

The light sensor (501) may comprise an image sensor or a spectrophotometer. Such light sensor may comprise electronic means for processing an image and to convert such image into a digital image. Light sensors may be used in electronic imaging devices of both analog and digital types, which may include digital cameras, thermal cameras, camera modules, medical imaging equipment, night vision equipment, radar or sonar, a spectrophotometer. A camera or radar may provide an information matrix from a complete image; in contrast, a spectrophotometer may provide a point to point measure of light values emanating from a substrate and may build a vector and or a matrix with such information.

An irradiance correlator (502) may be any device with processing means capable of correlating image values, such as color values, into values of irradiance values, given an area of a substrate to analyze. For example, the correlator may be configured to correlate L*ab parameters of a scanned image into irradiance values per cm².

A control unit (503) in communication with the radiation source may comprise regulating means, for example a power increaser, for regulating, increasing or decreasing power of a radiation emitter or replacing tooling to replace the emitter or a part of the emitter, for example, an area or region of a set of UV-LED lamps; a region of UV-LED lamps may present dimensions such as 4 cm×6 cm of UV-LEDs. The control unit may receive instructions to calibrate the radiation emitter. The control unit may decide to regulate the radiation emitter in response to determining a deviation of an irradiance of a scanned substrate. The control unit may receive instructions to regulate from a user interface, whereby the user interface may alert of a deviation in a specific area. The user interface may comprise a display to show an irradiance map per surface area of the substrate to a user; subsequently, the user may decide upon regulation of the radiation emitter depending on the image shown in the display. The control unit (503) may be in wired or wireless communication with the radiation source (not shown). For example, a wired communication may comprise a communication through Ethernet technology. A wireless communication may comprise a short-range communication technology, for example, Bluetooth, e.g. BLE—Bluetooth Low Energy, NFC, Zigbee or WiFi technology. If the control unit is far away from the radiation source, they may be connected through long-range wireless communication technologies such as GSM, GPRS, 3G, 4G, 5G or satellite technology or wired technologies, for example, through optical fiber, ADSL, etc.

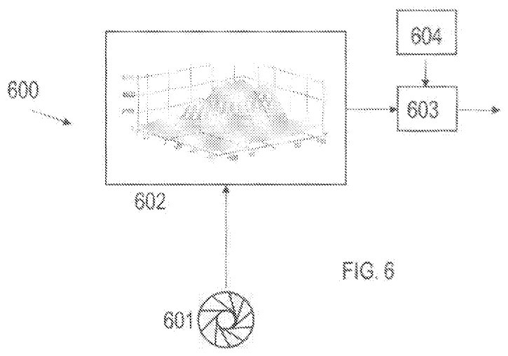

As seen in FIG. 6, where a system (600) is shown comprising an light sensor (601), an irradiance correlator (602) and a control unit (603), a system may further comprise a determiner (604) to determine a deviation of the irradiance value with respect to an expected value or range of values, and wherein the control unit is to regulate the radiation source in response to a signal sent by the determiner.

The determiner (604) may be in a remote location to the light sensor (601), correlator and control unit. The signal sent by the determiner may comprise the deviation of the irradiance value with respect to an expected value or range of values, and the control unit may regulate the radiation emitter after reading a deviation and after evaluating that such deviation requires calibration, i.e.: adjustment or replacement of the emitter or part of the emitter. Such signal may comprise instructions to regulate the radiation emitter and the emitter may receive instructions without the need of evaluating whether a deviation requires calibration of the emitter. Such a system with the determiner (604) in a remote location may allow a remote control-center to manage a printing system remotely. For example, a set of printers geographically distributed may be managed and controlled by a remote control-center. Such control-center may provide statistics of use or deterioration or calibration or regulation of radiation emitters in different printers.

The light sensor (501, 601) may comprise a scan bar as a data acquisition member.

A scan bar or scanner array may be made up of individual scanning heads or sensors. In some printers, the array of scanning heads may cover a whole dimension of the substrate, for example, the width may be covered and scanned by the scan bar. The scan bar may present at least a dimension equal or larger than at least a corresponding dimension of a substrate. The scan bar may present at least a dimension shorter than at least a corresponding dimension of a substrate. The scan bar may be moved over the printed side of the substrate, wherein the substrate may be fixed. The scan bar may be fixed, and the substrate may move, such that a printed side of the substrate is scanned by the scan bar.

The light sensor (501, 601) may comprise a spectrophotometer as a data acquisition member on a scanning carriage. In some examples, the scanning carriage presents dimensions comprised within the dimensions of a substrate. In some examples, the scanning carriage presents dimensions larger than or equal to the dimensions of a substrate. In some examples, a light sensor, for example a spectrophotometer with a lens comprising dimensions 1 cm×1 cm or 2 cm×1 cm or similar, may scan portions of the printed side of a substrate, which portions may present dimensions such as 3 mm×3 mm which may be known as a scanning pattern. After scanning a group of portions defining a predetermined area of the printed substrate, the spectrophotometer may provide an image which color values may be processed to obtain an irradiance applied on the substrate. The light sensor may be mounted on a scanner carriage which may move relative to the substrate such that a complete surface may be scanned.

In some examples, a heating or radiation emitter may be independent from a printing system. For example, the heating system may be adjacent to the printing system.

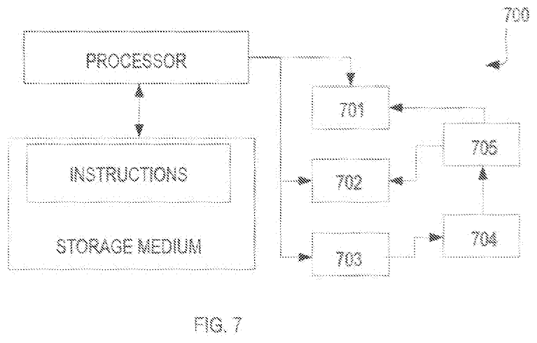

FIG. 7 is a block diagram of an example system (700) according to the present disclosure. Such a system (700) may be comprised in a printing system or may comprise a printer. The system (700) may comprise an interface to communicate with a printing device. The system may comprise a computing device or a controller, such as a personal computer, a server computer, a printer, a smartphone, a tablet computer, etc. The system (700) may comprise a processor and a machine-readable storage medium or data storage coupled to the processor. The processor may for example be any one of a central processing unit (CPU), a semiconductor-based microprocessor, an application specific integrated circuit (ASIC), and/or other hardware device suitable for retrieval and execution of instructions stored in the machine-readable storage medium or data storage. The apparatus 700 may comprise a print head (701) to deliver or eject a print agent onto a print zone of a substrate, a radiation source (702) to sublimate the print agent, a light sensor (703) to provide a scan of at least part of a sublimated print agent, the print agent deposited on a substrate and sublimated by the radiation source (702), an irradiance correlator (704) to correlate the scan to an irradiance value and a control unit (705) in communication with the radiation source (702) to regulate the radiation source in response to a deviation of the irradiance value with respect to an expected value or range of values.

In some examples, the print head (701) may travel repeatedly across a scan axis for delivering print agent onto a print substrate advancing along the advancing direction. In some examples, the print head may be static. The plurality of nozzles may be distributed within the print head along the width of the print substrate. Such an arrangement may allow most of the width of the print substrate to be printed simultaneously. Such printer systems may be called as page-wide array (PWA) printer systems.

In some examples, the radiation source (702) may be positioned after the print head (701) following an advancing direction of the print substrate. In some examples, the radiation source or radiation emitter (702) may be integrated with the print head, e.g. in movable or in fixed print heads. This may be the case in heating for drying a print agent.

In some examples, a light sensor (703) may comprise a spectrophotometer which may be embedded into a printing system, such as a sublimation printer. A spectrophotometer may typically be used to determine the composition of the light that is reflected from a color patch. A spectrophotometer measures the energy of each color. The printer may comprise a built-in white calibration tile for calibrating the printing colors so that and color accuracy is ensured. Such a spectrophotometer may be used for implementing a method according to the present disclosure, to provide a status of the radiation emitter or even to calibrate the radiation source.

The processor may fetch, decode, and execute instructions of an instruction set stored on a machine-readable storage medium to cooperate with the processor and the data storage according to this disclosure for image sensing at least part of a print agent after deposition onto a print substrate and after heating by a radiation emitter, obtaining, based on the image sensing, an irradiance applied on the heated print agent and for providing a status of the radiation emitter in response to determining a deviation of the irradiance with respect to an expected irradiance. The processor and modules may be configured to operate according to any of the methods described in this disclosure.

In some examples, a print system may comprise a plurality of heating systems or radiation emitters (702) according to any of the examples herein disclosed. For example, page-wide array printer systems may comprise a plurality of heating systems distributed along the width of the print substrate.

In some examples, the radiation emitter (702) may emit radiation in a relatively narrow band. Light-emitting diodes (LED's) or laser diodes are examples of radiation emitters with a relatively narrow band.

In some examples, the radiation emitter (702) may emit radiation in a relatively wide band, e.g. in the whole infrared spectrum. A radiation emitter emitting in a wide band may involve higher heating up times.

In some examples, the radiation emitter may emit infrared (IR) radiation. Infrared radiation may have a wavelength between 700 nm and 1 mm. In some examples, the radiation emitter may emit ultraviolet (UV) radiation. An infrared radiation emitter may emit a wavelength in the visible spectrum. Ultraviolet radiation has a wavelength between 10 nm and 400 nm.

In some examples, the processor may control the operation of the heating system or radiation emitter (702). In some examples, the processor may be an application specific processor for the heating system. In some examples, the processor may be integrated in a printing system or independent from the heating system or independent from the printing system.

In some examples, the heating system may comprise a sensor for obtaining the temperature of the radiation emitter. The sensor may be communicatively connected to a processor.

In some examples, a transitory or a non-transitory machine-readable storage medium encoded with instructions executable by a processor, comprises:
instructions to capture one or more color properties of at least part of a heated print agent deposited onto a print substrate by a radiation source:
instructions to determine an irradiance applied on the pre-printed image;
instructions to control the radiation source in response to an evaluation of a deviation of the determined irradiance with respect to a reference irradiance.

The machine-readable storage medium or data storage may be any electronic, magnetic, optical, or other physical storage device that contains or stores executable instructions. Thus, the machine-readable storage medium may be, for example, Random Access Memory (RAM), an Electrically Erasable Programmable Read-Only Memory (EEPROM), a storage device, an optical disc, and the like. In some implementations, the machine-readable storage medium may be a non-transitory machine-readable storage medium, where the term “non-transitory” does not encompass transitory propagating signals. Machine-readable storage medium may be encoded with a series of instructions executable by a processor. The instructions may cause a processor to carry out any of the methods described in this disclosure.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

1. A method for providing a status of a radiation emitter of a printing device, the method comprising:
image sensing at least part of a print agent after deposition onto a print substrate and after heating by the radiation emitter;
obtaining, based on the image sensing, an irradiance applied on the heated print agent;
providing a status of the radiation emitter in response to determining a deviation of the irradiance with respect to an expected irradiance.

2. A method in accordance with the method of claim 1 further comprising calibrating the radiation emitter when the status is a calibrating status.

3. A method in accordance with the method of claim 1 wherein obtaining an irradiance comprises translating one or more color values obtained at the image sensing step into an irradiated power per surface unit of the at least part of the print substrate.

4. A method in accordance with the method of claim 1 wherein obtaining an irradiance comprises translating one or more parameters of a color space obtained at the image sensing step into an irradiated power per centimeter squared of the at least part of the print substrate.

5. A method in accordance with the method of claim 1 wherein obtaining an irradiance comprises translating one or more color values obtained at the image sensing step into an irradiated power per surface unit, based on one or more parameters comprising: the print substrate, a distance between the print substrate and the radiation emitter, an image sensor aperture, an image sensor illumination, a light source position with respect to the print substrate, light incidence angle on the print substrate.

6. A method in accordance with the method of claim 1 wherein a deviation of the irradiance with respect to an expected irradiance comprises a subtraction of one or more irradiance values applied on the print substrate from one or more expected irradiance values.

7. A method in accordance with the method of claim 1 further comprising, before performing the image sensing:
depositing a print agent onto a print substrate; and
heating the print agent by the radiation emitter.

8. A method in accordance with the method of claim 7 wherein:
depositing a print agent onto the print substrate comprises depositing print agent to print a first part, out from a first and a second part, of a print job;
heating comprises heating at least part of the deposited print agent by the radiation emitter;
image sensing comprises image sensing at least part of the heated print agent;
obtaining an irradiance comprises obtaining an irradiance applied on the at least part of the heated print agent based on the image sensing;
and wherein the method further comprises
calibrating the radiation emitter when the status is a calibrating status;
depositing further print agent onto the print substrate to print the second part of the print job.

9. A method in accordance with the method of claim 7 wherein:
depositing a print agent onto the print substrate comprises depositing print agent to print a first part, out from a first and a second part, of a print job;
heating comprises heating at least part of the deposited print agent by the radiation emitter;
image sensing comprises image sensing at least part of the heated print agent;
obtaining an irradiance comprises obtaining an irradiance applied on the at least part of the heated print agent based on the image sensing;
and wherein the method further comprises calibrating the radiation emitter when the status is a calibrating status;
depositing further print agent onto the print substrate to print the second part of the print job;
and wherein a first part and a second part of the print job cover areas of variable surface of the print job based on properties of the print job.

10. A method in accordance with the method of claim 1 further comprising calibrating printing parameters in response to determining a deviation of the irradiance with respect to an expected irradiance.

11. A system for regulating a radiation source, comprising
a light sensor to provide a scan of at least part of a sublimated print agent, the print agent deposited on a substrate and sublimated by the radiation source;
an irradiance correlator to correlate the scan to an irradiance value;
a control unit in communication with the radiation source to regulate the radiation source in response to a deviation of the irradiance value with respect to an expected value or range of values.

12. A system method in accordance with the system of claim 11 further comprising a determiner to determine a deviation of the irradiance value with respect to an expected value or range of values, and wherein the control unit is to regulate the radiation source in response to a signal sent by the determiner.

13. A system according to claim 11 wherein the light sensor comprises:
a scan bar;
and/or a spectrophotometer.

14. A printing system comprising:
a print head to deliver a print agent onto a print zone of a substrate;
a radiation source to sublimate the print agent;
a system for regulating the radiation source according to claim 11.

15. A machine-readable storage medium encoded with instructions executable by a processor, the machine-readable storage medium comprising:
instructions to capture one or more color properties of at least part of a heated print agent deposited onto a print substrate by a radiation source;
instructions to determine an irradiance applied on the pre-printed image;
instructions to control the radiation source in response to an evaluation of a deviation of the determined irradiance with respect to a reference irradiance.
